(19) United States
(12) Patent Application Publication
(10) Pub. No.: US 2012/0091008 A1
(43) Pub. Date: Apr. 19, 2012

(54) PH MEASUREMENT DEVICE

(75) Inventors: Beinn V. O. Muir, London (GB); Eleni Bitziou, London (GB); Danny O'Hare, Brighton (GB); Peter Knox, London (GB)

(73) Assignee: MEDERMICA LIMITED, London (GB)

(21) Appl. No.: 13/319,042

(22) PCT Filed: May 4, 2010
(86) PCT No.: PCT/GB10/00882

§ 371 Date: Jan. 3, 2012

(30) Foreign Application Priority Data
May 5, 2009 (GB) 0907697.7

(51) Int. Cl. G01N 27/403; G01N 27/333; C25D 9/04; B32B 37/00; B32B 38/04; G01N 27/414; G01N 27/28

(52) U.S. Cl. 205/316; 204/433; 204/406; 156/293; 156/280; 205/333; 156/256; 205/787.5; 204/400

(57) ABSTRACT

A fluid sampling element is adapted to receive a fluid sample, but also includes a pH sensor element adapted to measure pH of the fluid sample and a reference sensor element. The pH sensor element and the reference sensor element are adapted to generate a potential difference between each other based on the pH of the fluid sample. The pH of the fluid sample can be measured and the fluid sampling element can then be readily disposed of.

### FIELD OF THE INVENTION

The present invention relates to a pH measurement device, which enables the pH of a fluid sample to be measured precisely. The pH measurement device can be for single-use and therefore disposable. In particular, the present invention relates to a fluid sampling element, fluid sampling system, a method of manufacture thereof, a method of determining the pH of a sample, a connector for connection to the fluid sampling element and a kit containing the fluid sampling element.

### BACKGROUND OF THE INVENTION

Devices for measuring the pH of samples are well known and are of huge importance in the laboratory and in industrial processes. These devices usually consist of a measuring electrode, a reference electrode, and an analyser or transducer. The measuring electrode exhibits a response that is sensitive to the hydrogen ion concentration, which causes a small voltage (for example ca. 0.06 V/pH unit) to be induced. This value is then converted into a pH value and is usually displayed on the device for the user to read.

A problem with these conventional devices is that, for precise work, the device needs to be calibrated by an end-user before each use. The probe on the device needs to be immersed in a minimum of two buffer solutions of known pH, which should span the range of pH values to be measured. Furthermore, conventional pH probes must be kept wet at all times when not in use, and must be kept in an appropriate medium so as to avoid diffusion of ions in and out of the probe, which causes degradation of the probe and leads to loss of function. Existing pH probes contain a reference electrode and a pH electrode, the bottom of which is surrounded by a thin glass bulb. The glass membrane contains the medium, which mixes with the outside environment. This membrane is extremely sensitive, and the medium (for example a potassium chloride solution) must be replenished due to ion loss and evaporation which causes a loss of precision in the measurements.

It is desirable to provide a method of precisely measuring pH without the need for the time-intensive calibration required for conventional devices and a device suitable for carrying out such measurement. A method and device for measuring pH of very small volumes of a sample within a sterile environment would be of particular importance when dealing with expensive or biologically sensitive media. This would also avoid the high levels of waste and/or contamination commonly associated with measuring the pH of samples using conventional pH meters. It is also desirable to provide a method of manufacturing a device for measuring the pH of very small volumes of a sample.

### SUMMARY OF THE INVENTION

The present invention, as defined by the appendant claims, aims to solve the aforementioned problems, particularly those associated with obtaining precise pH measurements without the need for prior calibration by an end-user, and without wasting large quantities of the fluid which is to be measured.

In a first aspect of the present invention, there is provided a fluid sampling element for receiving a fluid sample comprising:
a pH sensor element adapted to measure pH of the fluid sample; and
a reference sensor element,
wherein the pH sensor element and the reference sensor element are adapted to generate a potential difference between each other based on the pH of the fluid sample.

The fluid sample may comprise a pure or nearly pure solution, or micro-particulate suspension, or colloid, or any combination thereof.

The fluid sampling element may be limited to hold a maximum volume of fluid up to 10 ml, or up to 5 ml, or up to 4 ml, or up to 3 m, or up to 2 ml, or up to 1 ml, or up to 900 μL, or up to 800 μL, or up to 700 μL, or up to 600 μL, or up to 500 μL, or up to 400 μL, or up to 300 μL, or up to 200 μL, or up to 100 μL, or up to 50 μL, or up to 40 μL, or up to 30 μL, or up to 20 μL, or up to 10 μL, or up to 5 μL. The fluid can subsequently be ejected from the fluid sampling element and the fluid sampling element can be disposed of, or discarded.

The fluid sampling element advantageously requires no calibration before use, since this is carried out during manufacture. One or more calibration factors for the particular sensor elements of a given fluid sampling element can be stored in measurement electronics connected to the sensor elements, and applied to the measured potential difference values obtained from between the electrodes, or applied to determined pH values.

Importantly, the fluid sampling element may be disposed of after use. The fluid sampling element may be used once, for example by being removed from sterile packaging and connected to a pipettor or other fluid sampling device. Thus, a user of the fluid sampling element does not need to worry that there are contaminants present in the fluid sampling element. Hence, in conjunction with an electronic measurement unit, the fluid sampling element provides a versatile and accurate pH measurement device which requires no calibration by an end-user.

The fluid sampling element may comprise a cavity, wherein the cavity comprises a first opening and a second opening, wherein the first opening is adapted to receive fluid through it from outside the fluid sampling element and the second opening is adapted to be connected to a fluid sampling device.

The cavity may be a pipette tip. The pipette tip may be fitted to a standard pipettor, such as the commonly available Gilson micropipettes, and may be disposable.

Preferably, the pH sensor element comprises a pH sensing electrode formed from a first conductive element, and the reference sensor element comprising a reference electrode formed from a second conductive element.

In one embodiment of the invention, the first conductive element passes from a first location inside the cavity to a second location outside the fluid sampling element and the second conductive element passes from a third location inside the cavity to a fourth location outside the fluid sampling element. The second and fourth locations are preferably located on an outer surface of the fluid sampling element.

The first and second conductive elements may advantageously not be insulated along their entire length which is contained within the cavity. In otherwords, the first and second conductive elements may be exposed substantially in their entirety along their entire length which is contained within the cavity. It has been determined that the length of conductive element exposed in the cavity (and hence in the fluid sample which may be present in the cavity) has no effect on the accuracy of the pH measurement determination of the present invention. Hence, by using non- insulated first and second conductive elements, the fluid sampling devices of the present invention can be made easily and cheaply. This also permits coating in situ of the base substrate of the conductive elements with a reactive coating (see below).

The first and second conductive elements may each pass through an aperture in a wall of the fluid sampling element and are each sealed within the aperture. This may be achieved by sealing the first and second conductive elements to the wall by a heat seal formed by the wall of the fluid sampling element being heat sealed to the first and second conductive elements at each respective aperture.

On the outside of the fluid sampling device, the first and second conductive elements may each connect to a conductive contact element, such as a copper or solder contact.

The fluid sampling element may alternatively comprise an absorbent material. Implementing the fluid sampling element as a pipette tip is also advantageous as it enables measurements to be achieved using only a small amount of sample, and within a sterile environment.

The first and second conductive elements may pass out directly of the second opening or sit on the internal surface of the first opening where they can then connect to conductive contact elements located on the sampling end of the fluid sampling device.

The first conductive element is a pH sensitive electrode and exhibits a response that is dependent on the hydroxide ion and/or proton concentration in the sample. It may consist of a base substrate of billets, wire or strips, which may be conductive and which is then covered in a covering material, which may be a metal oxide or halide, e.g. iridium oxide. In a preferred embodiment, the iridium oxide is present as [IrO₂(OH)₂₋ₓ(2+x)H₂O]^{(2-x)-}, where 0.12<x<0.25. Typically, iridium oxide is present as a mixture of Ir₂O₃(OH)₃.3H₂O and [IrO₂(OH)₂.2H₂O]²⁻.

When reference is made herein to iridium oxide, it will be appreciated that this means both iridium oxide in its pure form and in a mixture. Other mixtures of covering material may be used and could include mixtures of metal complexes.

In one embodiment of the invention, the internal surface of the fluid sampling element may be used as the base substrate. The covering material is conductively connected to measurement electronics, even if the base substrate itself is not conductive.

Suitable materials for the base substrate include, but are not limited to, metals, for example platinum, antimony, bismuth, copper, tungsten, silver, molybdenum, palladium, aluminium, indium, iridium; non-metallic conductive polymers; and carbon based systems such as fullerenes and nanotubes, or any combination thereof. One preferred example of a combination of metals for the base substrate is a mixture of iridium and palladium. The composite conductive elements can be assembled as discrete components, or may alternatively be assembled by deposition of the covering material onto the base substrate, for example by techniques including sputtering, evaporation, electrolysis, physical vapour deposition, chemical vapour deposition, electroless deposition or any combination of such techniques, either simultaneously or sequentially. The resulting pure, alloyed, structured and/or layered conductive element may be modified by techniques such as electrodeposition into a form whose interfacial potential is systematically related to pH.

A calibration measurement can be obtained during the manufacturing process of a particular conductive element, for example by using three or more buffer solutions of known pH to evaluate the electrode sensitivity. The electrical potential difference per pH unit change can be derived from the potential response vs. pH as a calibration value. Once one such electrode has been calibrated and its electrical response has been derived, it is straightforward to manufacture many more identical or similar electrodes. Once manufactured and calibrated, there is no need for further calibration by an end-user.

The second conductive element may be a reference electrode with an interfacial electrical potential which is substantially independent of the sample pH. A suitable material for the reference electrode is any low resistance conductor or wire, but might include: Ag|AgCl, Ag|Ag⁺, Ag|Ag₂O, Ag|Ag₂S, Hg|HgS, Hg|HgO, Hg₂Cl₂|Hg (calomel), Pt|H₂, Pd|H₂ (including palladium halides), quinone|quinhydrone or other non-metallic complexes or organic polymers.

Again, like the pH sensitive electrode, the reference electrode can be readily manufactured on a large scale without the need for prior calibration by the end-user.

In use, when the pH sensitive electrode and reference electrode are in contact with the fluid sample, a potential difference is generated between the electrodes. In actual fact, a potential difference is established at the interface between the fluid sample and each of the pH sensor element and reference sensor element. The potential difference between the pH sensor element and reference sensor element can be measured by reference to the reference sensor element. The potential difference between the two phases (i.e. fluid sample and reference sensor element) is of a known value for a given material of the reference sensor element. Once the measured potential is established, the pH of the fluid sample can be calculated using an appropriate algorithm or lookup table.

In a second aspect of the invention, there is provided a fluid sampling system comprising:
a fluid sampling element as described above; and
a fluid sampling device connected to the fluid sampling element and adapted to draw a fluid sample into the fluid sampling element.

The fluid sampling device may optionally be a pipettor, and may further comprise a measurement unit adapted to be connected to a pH sensor element and reference sensor element. Preferably, the measurement unit is configured to determine the electrical potential difference between the pH sensor element and the reference sensor element, and may be adapted to display the potential difference. This enables the pH of the fluid sample to be calculated based on the potential difference. The fluid sampling device may itself be adapted to display the pH. The measurement unit is also adapted to store one or more calibration values for a given fluid sampling element. The calibration values are applied to the measured potential differences or the calculated pH values, e.g. by multiplication and/or addition/subtraction of an offset.

The calibration values for a given fluid sampling element can be input manually into the measurement unit by, for example, reading the values from packaging containing the fluid sampling element, or from a surface of the fluid sampling element itself. Alternatively, the calibration values may be stored in read only memory (ROM) which is located on the fluid sampling element. When the fluid sampling element is connected to the pipettor, the measurement unit may connect to ROM on the fluid sampling element (via electrical contacts, wireless means, or otherwise) and read the calibration values from the ROM into the measurement unit. Hence, the measurement unit obtains calibration values for a given fluid sampling element in an easy and/or automatic way. No further calibration is required by a user of the fluid sampling element, following its initial calibration during manufacture.

The measurement unit may also comprise a transmitter to transmit data representative of the pH or potential difference wirelessly to a receiver.

In a third aspect of the invention, there is provided a method of manufacturing the aforementioned fluid sampling element with a hollow cavity comprising:
inserting a pH sensor element into the cavity of the fluid sampling element; and
inserting a reference sensor element into the cavity of the fluid sampling element.

In one embodiment of the present invention, the step of inserting the pH sensor element into the cavity may comprise:
heating the pH sensor element; and
forcing the heated pH sensor element through a wall of the cavity such that the wall softens and subsequently hardens around the pH sensor element where it extends through the wall, thereby forming a seal.

In addition, the step of inserting the reference sensor element into the cavity may also comprise:
heating the reference sensor element; and
forcing the heated reference sensor element through a wall of the cavity such that the wall softens and subsequently hardens around the reference sensor element where it extends through the wall, thereby forming a seal.

Preferably, the pH sensor element initially comprises substantially only a base substrate and the method further comprises coating the pH sensor element in situ once inserted into the fluid sampling element with a metal oxide or metal halide. This provides a very effective method of manufacture of the fluid sampling elements.

Also, preferably, the reference sensor element initially comprises substantially only a base substrate and the method further comprises coating the reference sensor element in situ once inserted into the fluid sampling element with a metal oxide or metal halide.

The coating step, particularly of the pH sensor element, may comprise coating in situ through electrolytic deposition with electrolyte solution used for coating being placed into the cavity after insertion of the base substrate components of sensor elements into the fluid sampling element. The external, exposed sections of the conductive elements can be connected to a power source to provide electric current for the deposition process. Alternatively, for deposition onto the pH sensor element only, a separate cathode may be placed into the depositing solution into which the fluid sampling element is placed.

The coating step, particularly of the reference sensor element, may comprise placing the fluid sampling element, with the base substrate of the reference sensor element inserted into the cavity, before the base substrate of the pH sensor element is inserted, into a chloridizing solution, for example a solution of potassium dichromate 3N hydrochloric acid. Subsequent to this, the fluid sampling element may be washed before the base substrate of the pH sensor element is inserted.

For coating of the pH sensor element, an aqueous solution comprising IrCl₄ may be used for the depositing solution.

Preferably, the pH sensor element and the reference sensor element are adapted to generate a potential difference between each other based on the pH of a fluid sample when present in the cavity. It is also desirable to form a first aperture and a second aperture in a body of the fluid sampling element, so that the pH sensor element can be inserted into the cavity through the first aperture and the reference sensor element can be inserted into the cavity through the second aperture.

The pH sensor element may be fabricated by forming an iridium oxide film on a conductive element.

The reference sensor element may be fabricated from a silver conductive element, and the element may be chloridised.

In a further aspect of the invention, there is provided a method of determining the pH of a fluid sample, which may comprise:
acquiring a fluid sample in a fluid sampling element; and
measuring the potential difference between a reference sensor element and a pH sensor element; and
determining the pH of the fluid sample based on the measured potential difference,
wherein the pH sensor element and the reference sensor element are positioned, at least in part, inside a body of the fluid sampling element and are adapted to generate a potential difference between each other based on the pH of the fluid sample.

This method may further comprise, prior to the step of acquiring the sample, attaching the fluid sampling element, which comprises the reference sensor element and pH sensor element, to a fluid sampling device,
wherein the step of acquiring comprises activating the fluid sampling device to draw the fluid sample into the fluid sampling device.

The method may also comprise connecting the pH sensor element and reference sensor element to a measurement unit adapted to perform the steps of measuring the potential difference and determining the pH of the fluid sample.

After the step of measuring the potential difference, the fluid sampling element may be detached from the fluid sampling device, for example by operating a user-activatable release mechanism and may be disposed of or discarded.

There is also provided a kit, comprising a hermetically sealed package comprising the fluid sampling element, wherein the package may contain a liquid such as pure water. The package may contain a humidified environment. Preferably, the relative humidity in the package having the humidified environment is in the range of 20 to 100%, 50 to 100%, 60 to 100%, 80 to 100% or 70 to 90%.

### BRIEF DESCRIPTION OF THE DRAWINGS

The present invention is now discussed with reference to the accompanying drawings, in which:-

FIG. 1 is a perspective view of a fluid sampling system according to one embodiment of the present invention;

FIG. 2a is a side view of a fluid sampling element according to one embodiment of the system of FIG. 1;

FIG. 2b is an enlarged side view of a section of the fluid sampling element of FIG. 2a;

FIG. 3a is a side view of a fluid sampling element according to another embodiment of the system of FIG. 1;

FIG. 3b is an enlarged side view of a section of the fluid sampling element of FIG. 3a;

FIG. 4a is a cross-sectional view of one embodiment of a connector which serves to connect the fluid sampling elements of FIGS. 2a and 3a to processing electronics;

FIG. 4b is a cross-sectional view of an alternative embodiment of the connector which serves to connect the fluid sampling elements of FIGS. 2a and 3a to processing electronics;

FIG. 4c is a cross-sectional view of a second alternative embodiment of the connector which serves to connect the fluid sampling elements of FIGS. 2a and 3a to processing electronics;

FIG. 5 is a cut-away perspective view of the collars of FIGS. 4a and 4b;

FIG. 6a is a schematic of one embodiment of electronics used in conjunction with the invention;

FIG. 6b is a schematic of one embodiment of electronics used in conjunction with the invention;

FIG. 7 is a perspective view of one particular embodiment of a fluid sampling element and

FIG. 8 is a line graph of the relationship between potential difference and pH according to the invention.

### DETAILED DESCRIPTION OF THE DRAWINGS

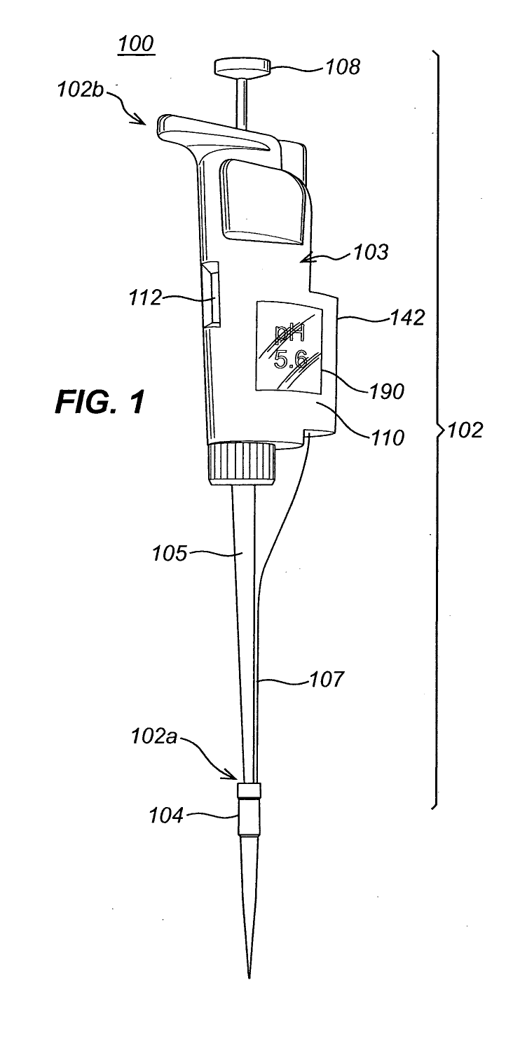

FIG. 1 shows a fluid sampling system 100, comprising a pipettor 102 with a pipettor body 103 and an attached fluid sampling element 104, which is a removable, disposable pipette tip. The fluid sampling element 104 is located at a distal end 102a of a hollow shaft 105 which extends at its proximal end from the body 103.

The dispenser button 108 is used to draw fluid sample into the fluid sampling element 104 by reducing the air pressure within the body 103 and the shaft 105 as the button 108 is retracted and pulled out of a proximal end 102b of the body 103 by a user. The pipettor 102 contains a spring mechanism connected to the button 108, so that, upon releasing the pressure applied to it, the button 108 retracts automatically, thereby drawing fluid into the fluid sampling element 104. When there is a fluid sample in the fluid sampling element 104, it may be ejected from the fluid sampling element 104 by applying downwards pressure to the dispenser button 108 to move it back towards the body 103 of the pipettor 102. The fluid sampling element 104 also comprises a handle 110 to facilitate a user gripping the pipettor 102, and a volumeter 112 to indicate the quantity of fluid contained within the fluid sampling element 104. An electronic unit 142 is integrated with the body of the pipettor 102 and comprises a display screen 190, which may be an LCD or other appropriate display indicator. The electronic unit 142 connects to an electrical connection 107 which connects the electronic unit 142 to contacts in the fluid sampling element 104 (see below).

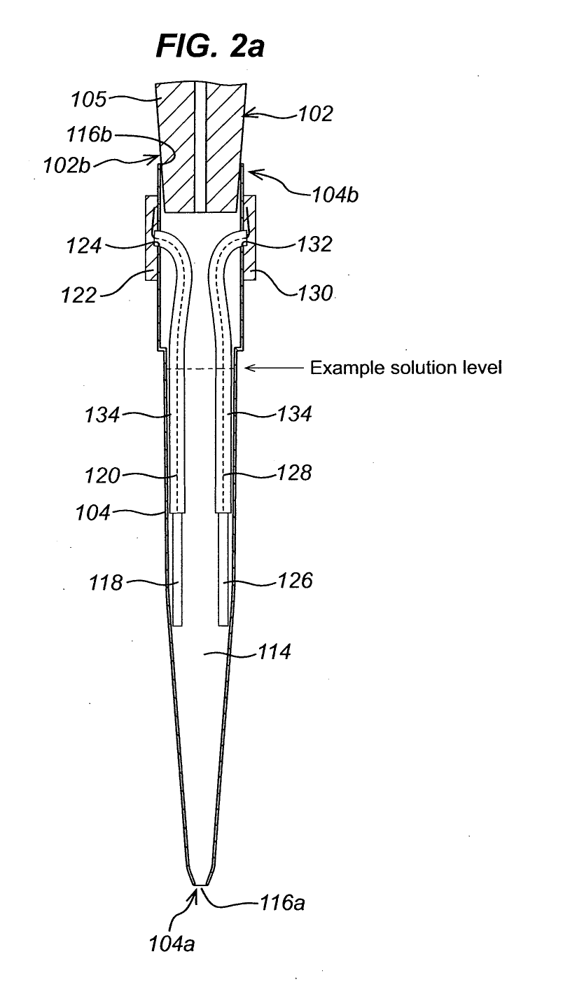

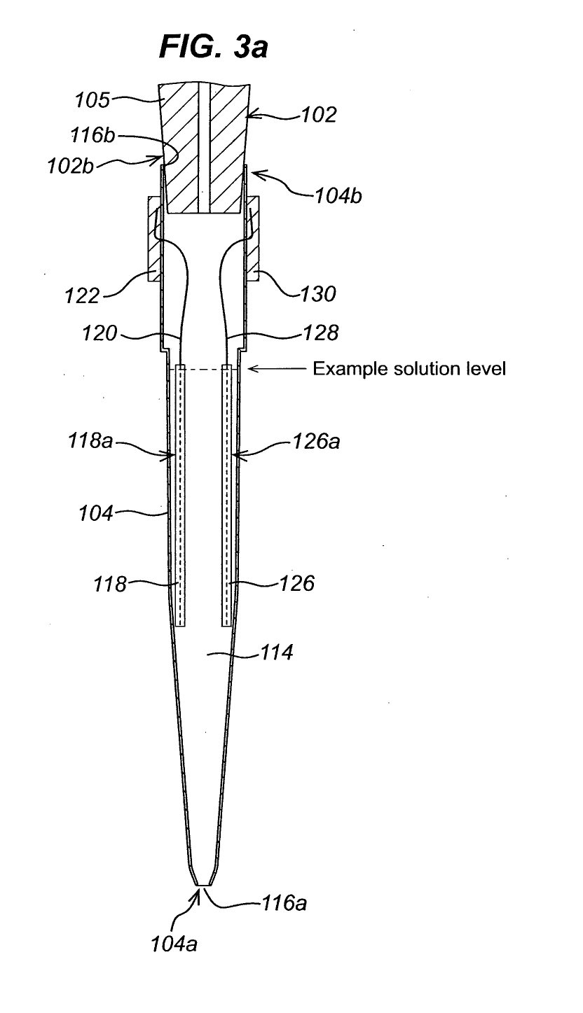

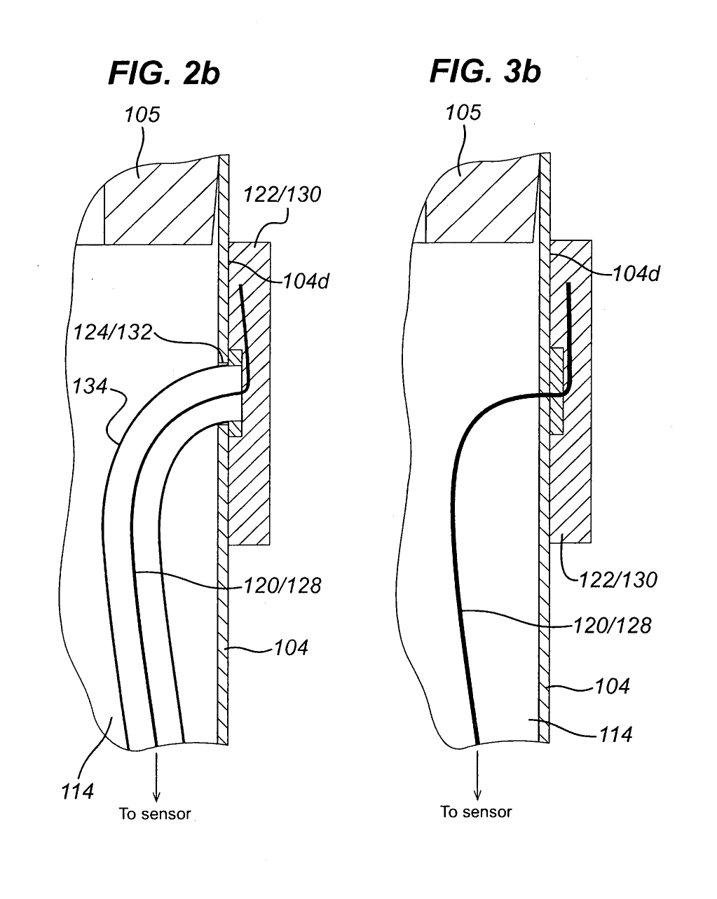

FIG. 2a shows a cross-sectional side view of one embodiment of the fluid sampling element 104. The fluid sampling element 104 is substantially conical in shape with its apex at a distal end 104a. The fluid sampling element 104 is formed of a transparent or opaque material (such as polyethylene) and comprises a cavity 114 which contains a first opening 116a at its distal end 104a through which the fluid sample is drawn. At an opposite, proximal end 104b, a second opening 116b, which is larger than the first opening 116a, is sized and dimensioned to fit over the pipettor distal end 102b or the shaft 105 and engage with it, so that the cavity 114 is sealingly engaged with the shaft 105.

A pH sensing electrode 118 is connected via a first conductive element 120 to a first conductive electrode contact 122 (a solder contact in the present embodiment, but any conductive contact may suffice, e.g. copper) through a first aperture 124 in the body wall of the fluid sampling element 104. The first conductive element 120 is coated in a metal oxide (see above) to form the pH sensing electrode 118 at its distal end. This pH sensing electrode 118 exhibits a response which is dependent on the hydroxide ion and/or proton concentration of the fluid sample contained in the cavity 114. A reference electrode 126 is connected via a second conductive element 128 to a second electrode contact 130 through a second aperture 132. The reference electrode 126 functions such that the interfacial electrical potential is effectively independent of the sample pH. Hence, when fluid sample is present in the cavity in contact with the electrodes 118, 126, an electrical potential difference is generated between the pH sensing electrode 118 and the reference electrode 126, which can be measured as a voltage.

The pH sensing electrode 118 of FIG. 2a is manufactured, in one embodiment of a manufacturing process, as follows:-
1. An insulated metal (e.g. gold) conductive wire (overall Ø 140 μm, 75 μm Ø Au) is cut radially, i.e. vertically to obtain a suitable segment of exposed wire on the insulated wire at one end.
2. A connection is formed at the exposed end of the wire to a connection wire and using a conductive adhesive.
3. The exposed metal wire is acid cleaned/etched using 0.5M H₂O₄ solution.
4. The clean exposed wire is immersed in a deoxygenated solution of iridium oxalate which may have a concentration in the range of 0.4 to 0.6 mM, preferably 0.5 mM, and a constant potential of 0.6 V to 0.7 V is applied vs. chloride-free reference electrode for 2 min to 4 min. An iridium oxide pH-sensitive film is thereby formed on the wire.
5. The coated wire is left for 2 days in deionised water to hydrate the pH-sensing film.
6. A calibration measurement is achieved using 3 or more buffer solutions of known pH to evaluate the electrode sensitivity (i.e. from the potential response vs. pH) and thereby derive the sensor's mV per pH unit change.
7. The sensory conductive wire is threaded into the fluid sampling element 104 through a first aperture 124 (<500 μm) and positioned inside the cavity 114 very close to the distal end 104a to achieve a pH reading even at the smallest volume of fluid sample.
8. The first aperture 124, through which the conductive wire was inserted, is sealed well.

The reference electrode 126 of FIG. 2a is manufactured, in one embodiment of the manufacturing process, as follows:-
1. An insulated silver conductive wire (overall Ø 140 μm, 125 μm Ø Ag) is cut using a scalpel blade and a connection is formed at one end using a connection wire and solder.
2. The other end of the conductive wire is removed from its insulating layer by burning off the insulating polymer without damaging the Ag conductive wire.
3. The exposed Ag wire is modified to Ag|AgCl wire using a commercially available chloridising solution based on sodium dichromate hydrate.
4. The Ag|AgCl conductive wire is threaded into the fluid sampling element 104 through the second aperture 132 (<600 μm) and positioned very close to the distal end 104a close to the pH sensor.
5. The second aperture 132, through which the conductive wire was inserted, is sealed well.

FIG. 2b shows the electrodes 118, 126 of FIG. 2a in more detail. The conductive element 120, 128 passes through the aperture 124, 132 into or onto the first or second conductive electrode contact 122, 130. Within the cavity 114 of the fluid sampling element 104, the conductive element 120, 128 is insulated, in part, and contained, in part, along its length within a coating 134, which may be formed from Teflon. The distal section of the first conductive element 128, which has been coated as described above, is therefore exposed over a predetermined length within the fluid sampling element 104. This distal section is the only exposed section of each conductive element 129, 128 within the fluid sampling element. It is this exposed section that contacts fluid which is drawn in the fluid sampling element. The coating 134 passes through the aperture 124, 132, where it is sealed and fixed to an outer surface 104d of the fluid sampling element 104. At its proximal end, the conductive element 120, 128 extends out of the insulating coating 134 and is juxtaposed or embedded with the conductive electrode contact 122, 130.

FIG. 3a shows a cross-sectional side view of another embodiment of the fluid sampling element 104. The size, shape, configuration and openings of this fluid sampling element are the same as those of the fluid sampling element shown in FIG. 2a.

In this embodiment, the pH sensing electrode 118 is connected via a first conductive element 120 to a first conductive electrode contact 122 (such as a solder contact in the present embodiment, but any conductive contact may suffice, e.g. copper) through a first aperture 124 in the body wall of the fluid sampling element 104. The first conductive element 120 is coated in situ with a metal oxide (see the process described below) to form a coating 118a of the pH sensing electrode 118 at its distal end. Again, this pH sensing electrode 118 exhibits a response which is dependent on the hydroxide ion and/or proton concentration of the fluid sample contained in the cavity 114. The reference electrode 126 is also connected via a second conductive element 128 to a second electrode contact 130 through a second aperture 132. The reference electrode 126 can be coated or chlorodised in situ in the fluid sampling element 104 to form a coating 126a. Again, the reference electrode 126 functions such that the interfacial electrical potential is effectively independent of the sample pH. Hence, when fluid sample is present in the cavity in contact with the electrodes 118, 126, an electrical potential difference is generated between the pH sensing electrode 118 and the reference electrode 126, which can be measured as a voltage.

The process of manufacturing the entire fluid sampling element 104 of the embodiment of FIG. 3a from a conventional, commercially available disposable pipette tip is as follows:-
1. For the reference electrode 126, at, for example, approximately 25 mm or less, from the tapered end of the pipette tip, a length of silver wire (i.e. the base substrate of the reference electrode 126) is introduced through the wall of the tip by heating the silver wire and applying gentle pressure. The silver wire could be of diameter 0.25 mm and be 99.99% pure. The wire is advanced such that there is, for example, approximately 2 mm visible in the lumen of the tip. After cooling, the silver wire is cut on the exterior aspect of the tip such that, for example, 5, 2, or 1 mm or less remains. remains exposed on the external surface.
2. In order to confirm integrity of the insertion and sealing process, a pipette dispenser can be used to introduce 500 microlitres of de-ionized water into the tip. If no dripping of fluid was observed for a period, e.g. ten seconds or more, the insertion process is considered successful.
3. In order to bring about chloridization of the silver wire inside the tip, chloridizing solution (e.g. 1 millilitre or less, or 500 microlitres or less) is introduced into the tip with a pipette dispenser and a reaction allowed to proceed at room temperature for a period of time, e.g. at least five, ten or twenty seconds or more. The chloridizing solution may consist of a saturated solution of potassium dichromate in 3N hydrochloric acid. Each tip containing a chloridized silver electrode is then washed a number of times, e.g. three times, with 1 millilitre of de-ionized water before continuing.
4. For the pH sensing electrode 118, a gold wire (i.e. the base substrate of the pH sensing electrode 118) is next inserted through the wall of the pipette tip substantially diametrically opposite the existing silver wire and at, for example, a distance from the tapered end of the tip of approximately 15 mm or less. The gold wire may be of diameter 0.25 mm and 99.99% pure. The wire is advanced such that there was, for example approximately 2 mm or less visible in the lumen of the tip. After cooling the gold wire is cut on the exterior aspect of the tip such that, for example, 5, 2, or 1 mm or less remains.
5. In order to confirm integrity of the insertion and sealing process a pipette dispenser, is used to introduce 500 microlitres of de-ionized water into the tip. If no dripping of fluid is observed for a period, e.g. ten seconds or more, the insertion process is considered successful.
6. The next stage in the process is to apply a conductive epoxy resin to the exposed silver and gold wires on the outside of the tip in order to facilitate electrical connection. In the example described here a commercial preparation from CircuitWorks™ (CW2400) may be used and the two components mixed according to manufacturer's instructions, although any conductive material which adheres to the tip and wires may be used. After bending the exposed silver and gold wires towards the body of the pipette tip, approximately 50 microliters of resin is applied and allowed to cure for a period until hard.
7. Then, an aqueous solution containing 1.5 gm IrCl4 per litre is prepared and, after adding 10 ml 30% hydrogen peroxide solution, 5 gm of anhydrous oxalic acid is added and stirred until dissolution is complete. Solid dipotassium carbonate is used to achieve a final pH of approximately 10.5. The solution is stirred at room temperature for a period, e.g. two days or more, by which time a deep blue colour has developed.
8. The iridium-containing solution is next used to introduce iridium oxide onto the surface of the gold wire inside, in situ, in the pipette tip. The gold wire within the tip is connected, for example via a clip placed on the epoxy connector to the anode of a 1.5 volt electrical supply. The cathode is a wire placed at the bottom of a reservoir of the iridium-containing solution. A pipette dispenser is used to take iridium-containing solution from the reservoir above the level of the distal end of the gold wire (e.g. 200 microlitres). The tip is maintained in the solution for a time period, e.g one minute or more, in order that electrical connection with the 1.5 volt source was continued.
9. After this, the electrical connections are removed and the tip is washed a number of times, e.g. three times, with 1 ml of de-ionized water.

FIG. 3b shows the electrodes 118, 126 of FIG. 3a in more detail. The conductive element 120, 128 passes through the aperture 124, 132 into or onto the first or second conductive electrode contact 122, 130. Within the cavity 114 of the fluid sampling element 104, the conductive element 120, 128 is not insulated in any way. The electrodes 118, 126 pass through the apertures 124, 132, where they are sealed into the apertures 124, 132 from the heat insertion/sealing process described above. The proximal ends of the electrodes 118, 126 sit on an outer surface 104d of the fluid sampling element 104. At its proximal ends, the conductive elements 120, 128 are juxtaposed or embedded with the conductive electrode contact 122, 130.

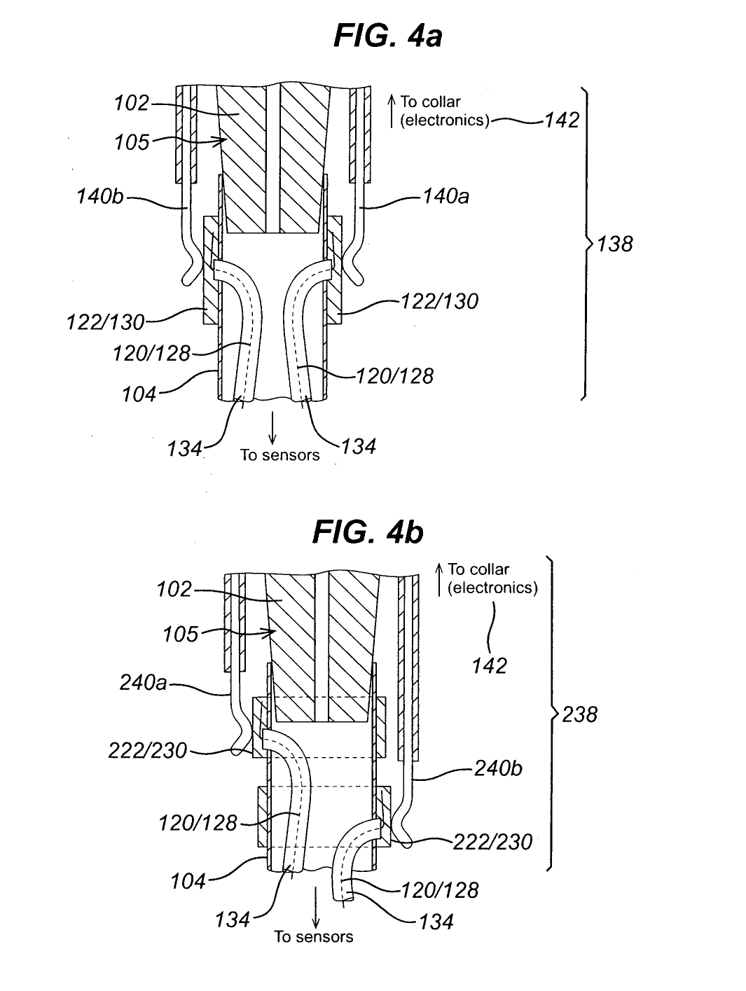

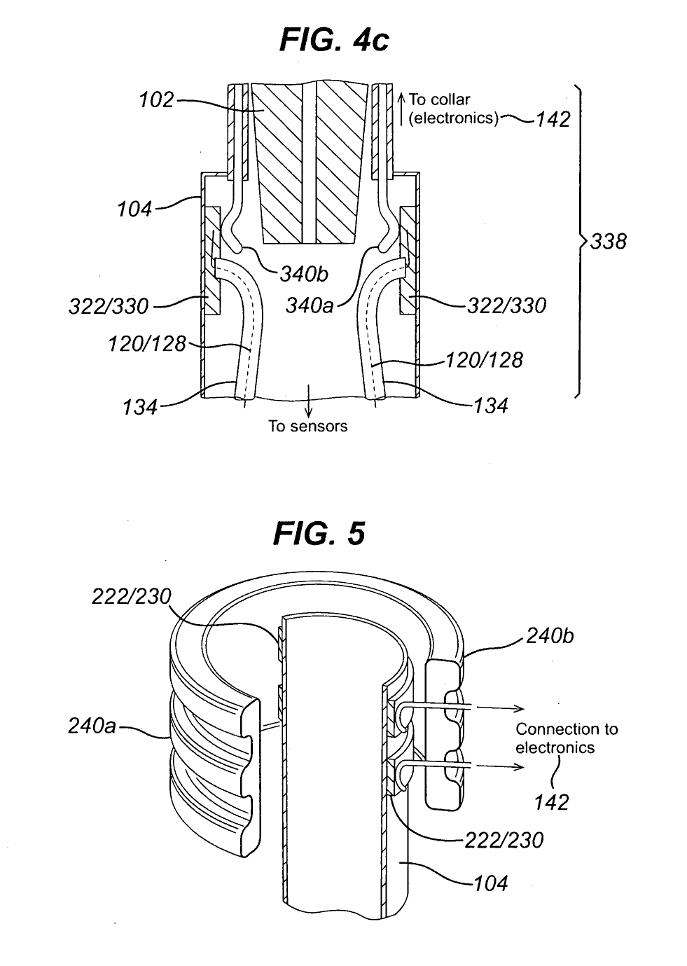

FIG. 4a shows one embodiment of a connector 138 which serves as a means for connecting the electrodes 118, 126 in the fluid sampling element 104 to conductors on the pipettor 102. The connector 138 comprises a pair of spring-loaded collar contacts 140a, 140b which are each in contact with one of the first or second electrode contacts 122, 130 and, on the other side, connect to an electrical connection 107 which connects each contact 140a, 140b to the electronic unit 142. The contacts 140a, 140b are biased into contact with the first and second electrode contacts 122, 130. The electrode contacts 140a, 140b are further connected to electronic unit 142 which may be housed externally and located on the pipettor 102 (as shown in FIG. 1), housed internally in the pipettor 102 or located separate from and away from the pipettor 102.

FIG. 4b shows an alternative embodiment of a connector 238 which functions in a similar way to the connector 138 described in FIG. 4a. However, in this embodiment, the contacts 240a, 240b are located, in part, on the pipettor 102 and are in contact with the electrode contacts 222, 230 at different points along the length of the fluid sampling element 104. Thus, the electrode contacts 222, 230 are separated in a longitudinal direction along the axis of the fluid sampling element 104. This permits the electrode contacts 222, 230 to extend around the entire circumference of the fluid sampling element (as shown, for example, in FIG. 5 discussed below).

FIG. 4c shows a second alternative embodiment of a connector 338 which functions in a similar way to the connector 138 described in FIG. 4a. However, in this embodiment, the connector contacts 340a, 340b are positioned juxtaposed on the distal end of the pipettor 102. The electrode contacts 322, 330 are located on an internal surface of the fluid sampling element 104. Thus, the electrode contacts 322, 330 are in contact with the connector contacts 340a, 340b internally within the fluid sampling element 104, between the external surface of the pipettor 102 and the internal surface of the fluid sampling element 104. This permits a good, tight electrical connection between the electrode contacts 322, 330 and the connector contacts 340a, 340b.

FIG. 5 shows a perspective cut-away view of an example connector 238 for use with the fluid sampling element 104 shown in FIG. 4b, in which the fluid sampling element 104 in is contact with the collar contacts 240a, 240b which are connected to the electronic unit 142. The electrode contacts 222, 230 extend around the fluid sampling element 104 which permits the fluid sampling element 104 to be attached to the end of the shaft 105 in any circumferential orientation without having to line up contacts, for example to provide a given polarity.

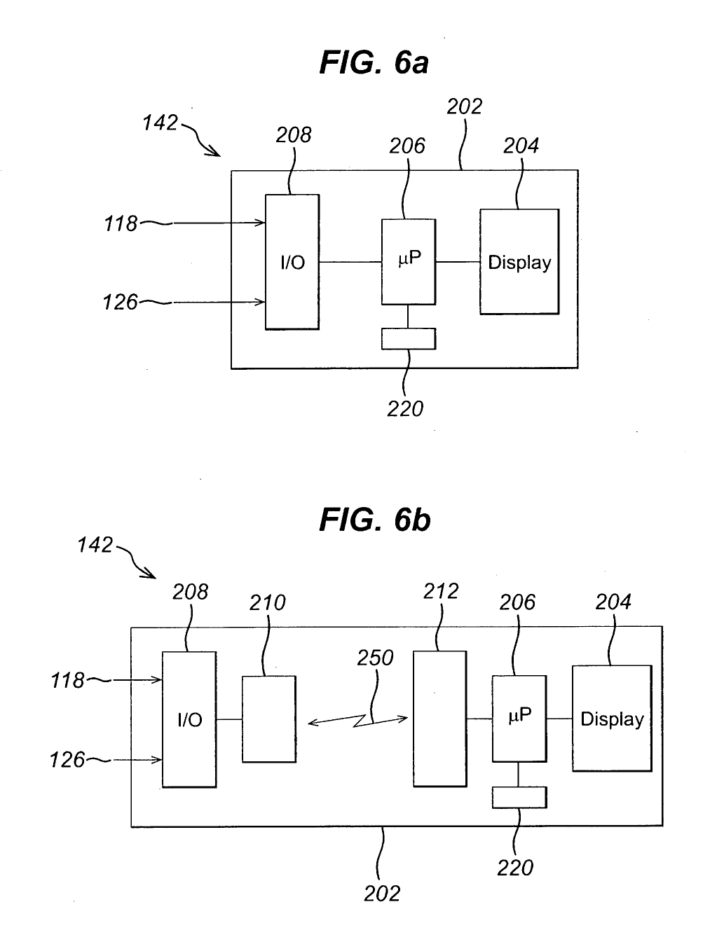

FIG. 6a is a schematic of one embodiment of the electronics 142, comprising a measurement system 202 including a display 204. The measurement system 202 comprises I/O section 208 connected to the electrodes 118, 126 and processor 206 which is configured to measure the potential difference generated between the electrodes 118, 126 as a result of the pH of the fluid sample. The processor 206 is configured to calculate the pH based on the measured potential (voltage) difference across the electrodes 118, 126 or current flowing between the electrodes 118, 126. The processor 206 is also configured to display the derived pH on the display 204 as a numerical value or as a graphical representation (e.g. colour or graphical scale). The measurement system 202 also stores one or more calibration values for a given fluid sampling element 104. The calibration values are applied by the processor 206 to the measured potential difference and/or the calculated pH, e.g. by multiplication and/or addition/subtraction of an offset.

In the embodiment of FIG. 6a, calibration values for a given fluid sampling element are input manually into the measurement system 202 by reading the values from packaging containing the fluid sampling element and inputting the values via input means 220 connected to the processor 206.

In one particular embodiment (not shown), the I/O section 208 is connected directly to a personal computer which performs the data processing, measurement and data storage functions provided by the aforementioned measurement system 202.

FIG. 6b is a schematic of an alternative embodiment of the electronics 142 comprising a measurement system 202 including an I/O section 208 which is connected to the electrodes 118, 126 and also connected to a first wireless communications transceiver 210 (e.g. RF or infra-red). The processor 206 is connected to a second wireless communications transceiver 212 which is adapted to receive a wireless signal 250 representative of the potential difference between the electrodes 118, 126 or the current passing from one electrode to the other through the I/O section 208, as transmitted from the first wireless communications transceiver 210. The processor 206 receives a signal indicative of the potential difference or current and from this calculates the pH of the fluid sample. The processor 206 is also configured to display the derived pH on the display 204 as a numerical value or as a graphical representation (e.g. colour or graphical scale). The processor 206 may also transmit setup and calibration data to the I/O section 210 from the second wireless transceiver 212 to the first wireless transceiver 210, and vice versa.

In one embodiment, the second wireless communications transceiver 212 may be connected to a personal computer which performs the data processing, measurement and data storage functions provided by the aforementioned measurement system 202.

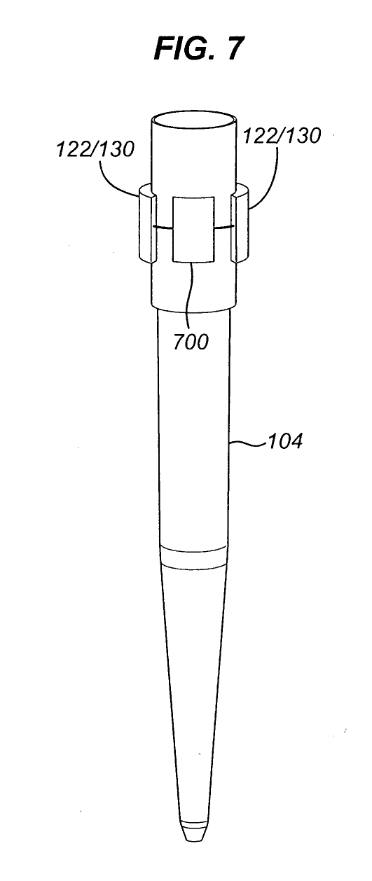

In one particular embodiment of the fluid sampling element 104 shown in FIG. 7 used with the measurement system 202 of FIG. 6a, calibration values are contained in read only memory (ROM) 700 which is located on the fluid sampling element 104. When the fluid sampling element 104 is connected to the pipettor, the measurement system 202 connects to the ROM 700 via the electrical contacts mentioned above and reads the calibration values from the ROM into the processor 206.

The calibration values are obtained during manufacture of the fluid sampling element 104. Calibration measurements are carried out during the manufacturing process of a particular first conductive element, for example by using three or more buffer solutions of known pH to evaluate the electrode sensitivity. The electrical potential difference per pH unit change is derived from the potential response vs. pH as a calibration value. A zero offset can also be derived and used as a further calibration value.

The calibration values are then written into the ROM 700 or, in an embodiment of the fluid sampling element 104, which does not include the ROM 700, the calibration values are printed, or otherwise shown, on the packaging containing the fluid sampling element 104 or on the fluid sampling element 104 itself.

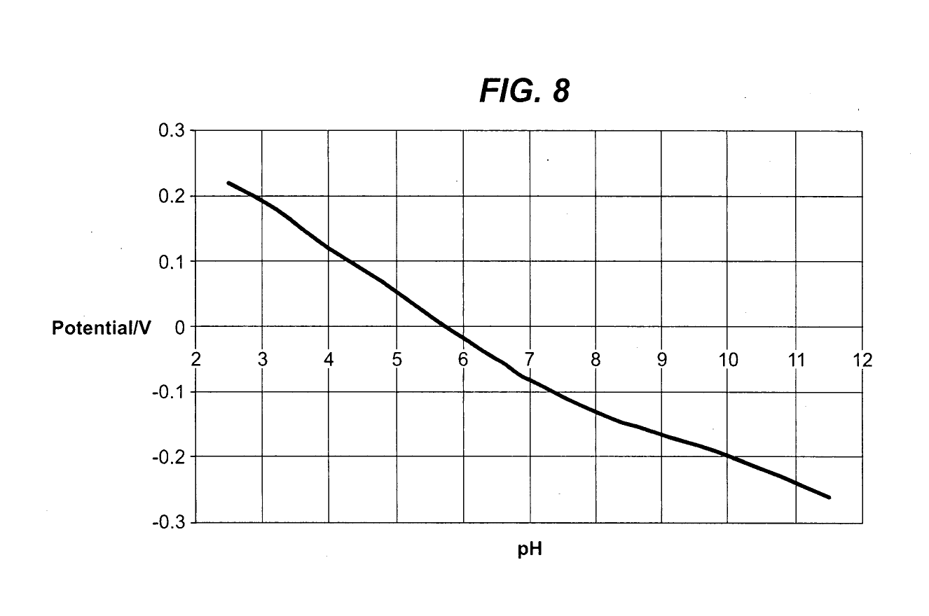

As mentioned above, the processor 206 receives a signal indicative of the potential difference or current and from this calculates the pH of the fluid sample. This calculation may be performed through a direct calculation, e.g. by multiplying the potential difference by a coefficient which relates potential difference to pH and adding or subtracting an offset. The coefficient and offset may be determined through the calibration process described above. Alternatively, the processor 206 may access a lookup table in the ROM 700 which relates potential difference values to pH values. An example of the relationship between potential difference generated by the electrodes 118, 126 over a range of pH values is shown in FIG. 8.

It will of course be understood that the present invention has been described above purely by way of example and modifications of detail can be made within the scope of the invention.

1. A fluid sampling element for receiving a fluid sample comprising:-
a pH sensor element adapted to measure pH of the fluid sample; and
a reference sensor element,
wherein the pH sensor element and the reference sensor element are adapted to generate a potential difference between each other based on the pH of the fluid sample.

2. The fluid sampling element of claim 1, wherein the fluid sampling element comprises a fluid holding element for containing the fluid sample and wherein the pH sensor element and reference sensor element are located in the fluid holding element so as to be in direct contact with the fluid sample.

3. The fluid sampling element of claim 2, wherein in the fluid holding element comprises a cavity.

4. The fluid sampling element of claim 2, wherein the fluid sampling element comprises an absorbent material.

5. The fluid sampling element of claim 1, wherein the pH sensor element comprises a pH sensing electrode formed from a first conductive element, and the reference sensor element comprising a reference electrode formed from a second conductive element.

6. The fluid sampling element of claim 5, wherein the first conductive element passes from a first location inside the cavity to a second location outside the fluid sampling element and the second conductive element passes from a third location inside the cavity to a fourth location outside the fluid sampling element.

7. The fluid sampling element of claim 6, wherein the second and fourth locations are located on an outer surface of the fluid sampling element.

8. The fluid sampling element of claim 6, wherein the first and second conductive elements are not insulated along their entire length which is contained within the cavity.

9. The fluid sampling element of claim 8, wherein the first and second conductive elements are exposed in their entirety along their entire length which is contained within the cavity.

10. The fluid sampling element of claim 6, wherein the first and second conductive elements each pass through an aperture in a wall of the fluid sampling element and are each sealed within the aperture.

11. The fluid sampling element of claim 10, wherein the first and second conductive elements are sealed in the wall by a heat seal formed by the wall of the fluid sampling element being heat sealed to the first and second conductive elements at each respective aperture.

12. The fluid sampling element of claim 6, wherein the first conductive element is inserted into an absorbent material.

13. The fluid sampling element of claim 5, wherein the first conductive element and second conductive element reside wholly within the fluid sampling element and are arranged such that conductive contact on each conductive element to a further conductor, which is located, in part, externally to the fluid sampling element, is made internally within the fluid sampling element.

14. The fluid sampling element of claim 6, wherein the first conductive element is connected to a first connection element on the outer surface of the fluid sampling element and the second conductive element is connected to a second connection element on the outer surface of the fluid sampling element.

15. The fluid sampling element of claim 5, wherein the first conductive element comprises a base substrate coated in a metal oxide or metal halide.

16. The fluid sampling element of claim 15, wherein the metal oxide comprises iridium oxide.

17. The fluid sampling element of claim 15, wherein the first conductive element exhibits a response which is dependent on hydroxide ion and/or proton concentration.

18. The fluid sampling element of claim 5, wherein the second conductive element is a reference electrode such that the interfacial electrical potential is effectively independent of the sample pH.

19. The fluid sampling element of claim 1, wherein the cavity comprises a first opening and a second opening, wherein the first opening is adapted to receive fluid through it from outside the fluid sampling element and the second opening is adapted to be connected to a fluid sampling device.

20. The fluid sampling element of claim 1, wherein the fluid sampling element is a pipette tip adapted to be connected to a pipettor.

21. The fluid sampling element of claim 1, wherein the fluid sampling element is disposable.

22. The fluid sampling element of claim 1, wherein the fluid comprises micro-particulate suspensions or colloids.

23. The fluid sampling element of claim 1, wherein the fluid comprises a pure solution.

24. The fluid sampling element of claim 1 wherein the pH sensor element is formed from a combination of metals.

25. A kit, comprising a hermetically sealed package comprising the fluid sampling element of claim 1.

26. The kit of claim 25, wherein the package comprises a pH neutral vapour or liquid, such as pure water.

27. The kit of claim 25, wherein the package contains a humidified environment.

28. A fluid sampling system comprising:
the fluid sampling element of claim 1; and
a fluid sampling device connected to the fluid sampling element and adapted to draw a fluid sample into the fluid sampling element.

29. The fluid sampling device of claim 28, wherein the fluid sampling device is a pipettor.

30. The fluid sampling device of claim 28, wherein the fluid sampling system comprises a measurement unit adapted to be connected to the pH sensor element and reference sensor element and configured to determine the electrical potential difference between the pH sensor element and the reference sensor element.

31. The fluid sampling device of claim 30, wherein the measurement unit comprises a display adapted to display the potential difference.

32. The fluid sampling element of claim 30, wherein the measurement unit is configured to calculate the pH of the fluid sample based on the potential difference.

33. The fluid sampling device of claim 32, wherein the measurement unit comprises a display adapted to display the pH.

34. The fluid sampling device of claim 30, wherein the measurement unit comprises a transmitter to transmit data representative of the pH or potential difference wirelessly to a receiver.

35. A method of manufacturing a fluid sampling element which comprises a hollow cavity comprising:
inserting a pH sensor element into the cavity of the fluid sampling element; and
inserting a reference sensor element into the cavity of the fluid sampling element.

36. The method of claim 35, wherein the step of inserting the pH sensor element into the cavity comprises:
heating the pH sensor element; and
forcing the heated pH sensor clement through a wall of the cavity such that the wall softens and subsequently hardens around the pH sensor element where it extends through the wall, thereby forming a seal.

37. The method of claim 35, wherein the step of inserting the reference sensor element into the cavity comprises:
heating the reference sensor element; and
forcing the heated reference sensor clement through a wall of the cavity such that the wall softens and subsequently hardens around the reference sensor element where it extends through the wall, thereby forming a seal.

38. The method of claim 35, wherein the pH sensor element initially comprises a base substrate and the method further comprises coating the pH sensor element in situ once inserted into the fluid sampling element with a metal oxide or metal halide.

39. The method of claim 35, wherein the reference sensor element initially comprises a base substrate and the method further comprises coating the reference sensor element in situ once inserted into the fluid sampling element with a metal oxide or metal halide.

40. The method of claim 38, wherein the step of coating comprises coating through electrolysis.

41. The method of claim 35, further comprising the step of fabricating the pH sensor element from a combination of metals.

42. The method of claim 35, wherein the pH sensor element and the reference sensor element are adapted to generate a potential difference between each other based on the pH of a fluid sample when present in the cavity.

43. The method of claim 35, comprising forming a first aperture and a second aperture in a body of the fluid sampling element, wherein the pH sensor element is inserted into the cavity through the first aperture and the reference sensor element is inserted into the cavity through the second aperture.

44. The method of claim 35, comprising fabricating the pH sensor element by &inning an iridium oxide film on a conductive element which is a base substrate.

45. The method of claim 35, wherein the reference sensor element is fabricated from a silver conductive element.

46. The method of claim 45, comprising fabricating the reference electrode by chloridising the silver conductive element.

47. A method of determining pH of a fluid sample, comprising:
acquiring a fluid sample in a fluid sampling element; and
measuring the potential difference between a reference sensor element and a pH sensor element; and
determining the pH of the fluid sample based on the measured potential difference,
wherein the pH sensor element and the reference sensor element are positioned, at least in part, inside a body of the fluid sampling element and are adapted to generate a potential difference between each other based on the pH of the fluid sample.

48. The method of claim 47, further comprising, prior to the step of acquiring, attaching the fluid sampling element, which comprises the reference sensor element and pH sensor element, to a fluid sampling device, wherein the step of acquiring comprises activating the fluid sampling device to draw the fluid sample into the fluid sampling device.

49. The method of claim 48, further comprising connecting the pH sensor element and reference sensor element to a measurement unit adapted to perform the steps of measuring the potential difference and determining the pH of the fluid sample.

50. The method of claim 48, further comprising, after the step of measuring the potential difference, detaching the fluid sampling element from the fluid sampling device and disposing of the fluid sampling element.

51. A connector for connection to a fluid sampling element comprising:
a body;
a first contact element on the body for connection to a pH sensor element on the fluid sampling element; and
a second contact element on the body for connection to a reference sensor element on the sampling element.

52. The connector of claim 51, wherein the fluid sampling element is a pipette tip.

53. The connector of claim 52, wherein the body is a hollow ring, wherein the first contact element and second contact element are mounted inside the ring and the body provides means for connecting the connector to the fluid sampling element as a result of friction between the inside of the ring between and an outer surface of the pipette.

54. The connector of claim 51, further comprising a wireless transmitter connected to the first contact element and second contact element and configured to transmit a signal representative of the potential difference between the first contact element and second contact element to a receiver.

55. A measurement system, comprising:
the connector of claim 51; and
a measurement unit connected via a first conductor to the first contact element and via a second conductor to the second contact element,
wherein the measurement unit is configured to measure the potential difference between the first conductor and second conductor.

56. A measurement system, comprising:
the connector of claim 54; and
a measurement unit comprising a receiver configured to receive the signal representative of the potential difference between the first contact element and second contact element.

57. The measurement system of claim 55, wherein the measurement unit is further configured to calculate the pH of a fluid sample in the fluid sampling element based on the potential difference.

58. The measurement system of claim 55, further comprising a fluid sampling element for receiving a fluid sample comprising:-
a pH sensor element adapted to measure pH of the fluid sample; and
a reference sensor element,
wherein the pH sensor element and the reference sensor element are adapted to generate a potential difference between each other based on the pH of the fluid sample.
